(19) United States
(12) Patent Application Publication
(10) Pub. No.: US 2004/0245328 A1
(43) Pub. Date: Dec. 9, 2004

(54) Door-in-door newspaper box cover

(76) Inventors: Patrick A. Schaper, Albion, IN (US); Dennis Adams, Columbia City, IN (US)

Correspondence Address: RANDALL J. KNUTH P.C., 3510-A STELLHORN ROAD, FORT WAYNE, IN, 46815-4631, US

(21) Appl. No.: 10/455,034

(22) Filed: Jun. 5, 2003

(51) Int. Cl. G07B 15/00

(52) U.S. Cl. 232/10

(57) ABSTRACT

A door assembly is available for a roadside delivery container, such as a newspaper box or open-ended mailbox. The roadside container has a container interior and an open container end to facilitate access to the container interior. The door assembly permits selective covering of the open container end. The door assembly includes a door frame having a frame opening therein, a container fastener, and a frame opening cover. The container fastener is pivotally mounted to the door frame. The container fastener is configured for pivotally attaching the door frame to the delivery container. The frame opening cover is pivotally mounted to the door frame and is configured for selectably covering the frame opening. Advantageously, the frame opening cover has a bifold design, making closing thereof possible under newspaper placement conditions that would have otherwise prevented closure.

### BACKGROUND OF THE INVENTION

1. Field of the Invention

The present invention relates to a newspaper box cover for a roadside delivery newspaper box, the newspaper box cover having a door-in-door construction.

2. Description of the Related Art

Roadside newspaper delivery boxes are commonly employed in areas (e.g., usually rural) where newspapers are delivered by a person driving a car or other vehicle. These newspaper boxes typically have a predominant longitudinal direction and an open end directed toward the road to thereby accommodate the insertion of a newspaper into the box. The cross section of the newspaper delivery box must be able to accommodate the generally larger Sunday edition of the paper in addition to the generally smaller weekday/Saturday editions thereof.

A problem with the basic newspaper box/tube design is the uncovered open end thereof. This open end allows at least the end of the newspaper nearest the open end to potentially be exposed to the elements, especially wind, rain, and snow, each of which could potentially damage the exposed end of the newspaper. The potential for exposure is especially true in a situation in which the newspaper has not been fully inserted into the newspaper box.

In response to this potential exposure problem, pivotal/hinged lids and/or gates have been created for mounting to a newspaper delivery receptacle at the open end thereof. Of the known prior art newspaper box door constructions, such doors are generally designed to facilitate the insertion of a newspaper (i.e., door swings inward) or its removal (i.e., door swings outward), but not both. Further, of the known prior art door system in which is to swing inward, that door system is not designed to facilitate closure of that door in a situation in which the newspaper has not been pushed far enough back into the newspaper box so as to be clear of the swing radius of the newspaper box door. Additionally, none of the known newspaper delivery box covers incorporate an indicator flag that is able to coact with the door in order to thereby indicate whether or not a newspaper has been delivered into the newspaper box.

What is needed in the art is a newspaper delivery box that will accommodate both the delivery insertion of a newspaper into the newspaper box and its removal therefrom.

What is further needed in the art is a newspaper box cover which has an improved ability to come to a closed position even if the newspaper is not pushed all the way back into the newspaper box.

What is also needed in the art is an indicator flag that is mounted with the door assembly that is able to coact with the movement of the door assembly so as to indicate whether or not a newspaper has been delivered, thereby allowing the delivery person to know whether or not a newspaper has been inserted far enough into the box to allow closure of the door as well as signaling the newspaper recipient of the paper delivery status.

### SUMMARY OF THE INVENTION

The present invention, in one form thereof, relates to a newspaper box door for an open, newspaper-receiving end of a newspaper box. The newspaper box has a box interior. The newspaper box door includes a door frame with a frame opening, a box fastener, and a frame opening cover. The door frame is configured for selective mounting around and adjacent to the open, newspaper-receiving end of the newspaper delivery box. The door frame has a newspaper-receiving frame opening formed therein. The box fastener is pivotally mounted to the door frame and is configured for attaching to the newspaper delivery box and for thereby releasably mounting the door frame to the newspaper delivery box. The box fastener facilitates a pivotal movement of the door frame selectively one of toward and away from the open, newspaper-receiving end of the newspaper delivery box. The frame opening cover is pivotally mounted to the door frame within the newspaper-receiving frame opening. The frame opening cover is configured for pivotal movement within the box interior.

The present invention, in another form thereof, relates to a newspaper box door for an open, newspaper-receiving end of a newspaper box, the newspaper box having a box interior. The newspaper box door includes a door frame with a frame opening, a box fastener, and a frame opening cover. The door frame is for selective mounting to the open, newspaper-receiving end of the newspaper delivery box, the door frame having the newspaper-receiving frame opening formed therein. The box fastener pivotally mounts to the door frame and is configured for attaching to the newspaper delivery box. The box fastener facilitates a pivotal movement of the door frame selectively one of toward and away from the newspaper delivery box. The frame opening cover pivotally mounts to the door frame within the newspaper-receiving frame opening. The frame opening cover is configured for pivotal movement within the box interior.

The present invention, in yet another form thereof, relates to a door assembly for a roadside delivery container. The roadside container has a container interior and an open container end to facilitate access to the container interior. The door assembly permits selective covering of the open container end. The door assembly includes a door frame having a frame opening therein, a container fastener, and a frame opening cover. The container fastener is pivotally mounted to the door frame. The container fastener is configured for pivotally attaching the door frame to the delivery container. The frame opening cover is pivotally mounted to the door frame and is configured for selectably covering the frame opening.

The present invention, in yet an even further form thereof, relates to a door assembly for a roadside delivery container. The roadside container includes a door frame having a frame opening, a fastener, and a frame opening cover. The fastener is pivotally mounted to the door frame. The fastener is configured for pivotally attaching the door frame to the container. The frame opening cover is pivotally mounted to the door frame and is configured for selectably covering the frame opening.

An advantage of the present invention is that the double door/door-in-a-door construction permits a double action of the door assembly of the present invention, thereby allowing easy insertion of the item to be delivered (e.g., a newspaper) in through the door yet facilitating easy access to the delivery receptacle (e.g., a newspaper box) by pivotal movement of the entire door assembly away from the open end of the receptacle.

Another advantage of the present invention is that the door-in-a-door assembly is bi-fold in nature which allows the inner door member (i.e., the door in the door) to have enough room to close under circumstances which would have otherwise prevented it to close had the bi-fold construction not been present.

A further advantage of the present invention is that the door assembly is both weather resistant and able to form a generally weather-tight closure with the delivery box to which it is connected.

A yet further advantage of the present invention is that the door cover, door frame, and box attachment member are each made of a clear material. By the door cover being clear, the presence of a newspaper or other delivered material in the delivery box can be visually ascertained. Additionally, the clear nature of the box attachment mechanism and the door frame allow for visual confirmation of the relative positioning of such parts with respect to the delivery receptacle.

An even yet further advantage of the present invention is that a single door assembly is versatile enough to fit on a variety of sizes of delivery boxes/tubes, the extent of its versatility limited essentially by the dimensions of the perimeter of the door frame.

A yet additional advantage of the present invention is that it can incorporate various artwork on the parts of the door assembly, thereby increasing its aesthetic value. Likewise, various material colors can be incorporated therein. Advantageously, the materials chosen can be both clear and colored to provide for both the aesthetic value of the colored materials while still allowing for visual checks to be performed.

A yet even further advantage of the present invention is that, while the primary embodiment of the invention employs the door assembly with a newspaper box, the use of the door assembly can be extended to other types of delivery receptacles such as mailboxes, especially delivery receptacles having an open end into which materials are to be delivered.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of a newspaper box having a newspaper box door of the present invention mounted thereon, the newspaper box door being in a generally closed position relative to an open end of the newspaper box;

FIG. 2 is a frontal, perspective view of the newspaper box door of the present invention; and

FIG. 3 is a rear, perspective view of the newspaper box door of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

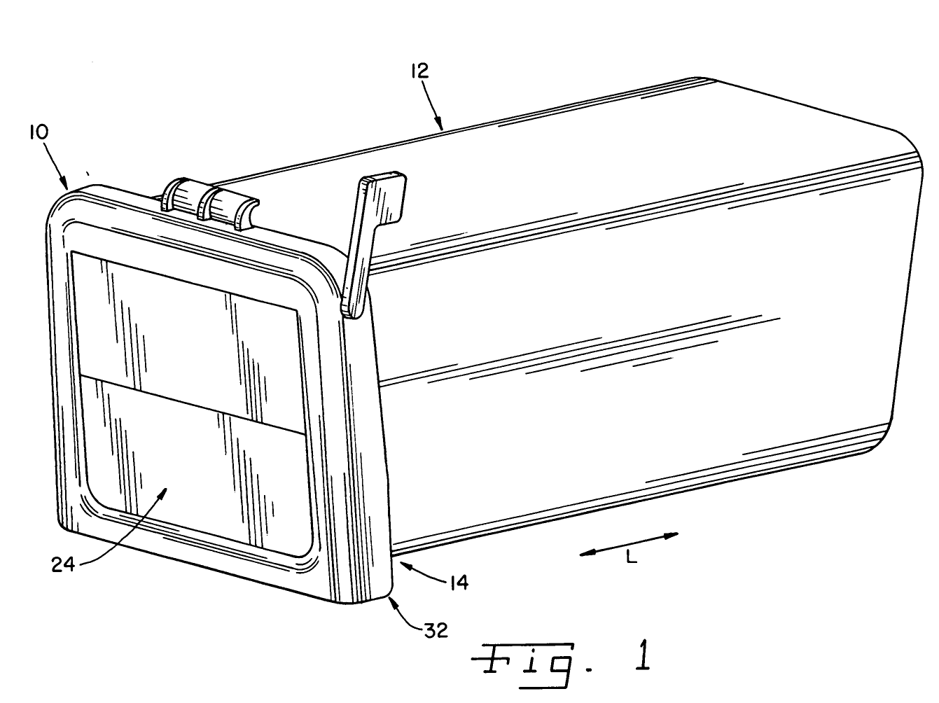

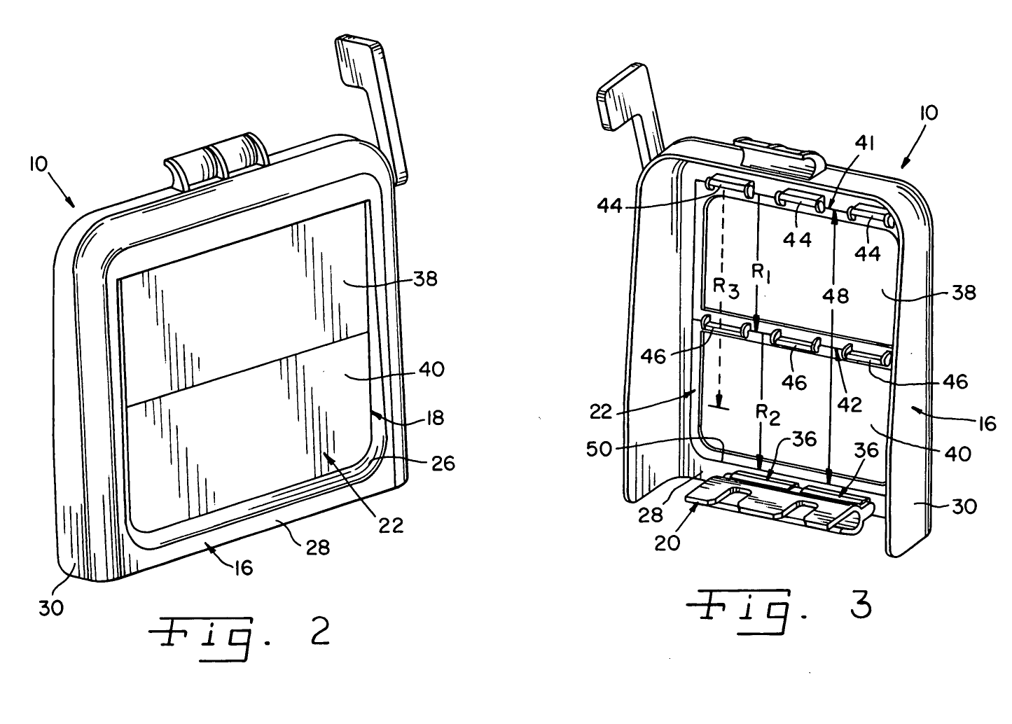

As shown in FIGS. 1, a newspaper box door 10 is configured for mounting to a newspaper box 12 at an open, newspaper-receiving end 14 thereof. Newspaper box door 10, as better seen in FIGS. 2 and 3, includes a frame 16 having a newspaper-receiving frame opening 18 therein, a box fastener 20, and a frame opening cover 22.

Newspaper box 12 is designed for roadside delivery of both a typical daily edition of a newspaper as well as the usually larger Sunday edition thereof. Such a newspaper box 12 can have various sizes and shapes, ranging from parallelepipeds to cylinders. A common variety has generally parallel sides with rounded corner portions. In any event, such roadside receptacles 12 are typically largest in their lengthwise direction L in order to accommodate the full length of a rolled up newspaper (not shown) within box interior 24 of newspaper box 12. Newspaper-receiving end 14 is typically at one of the longitudinal ends of newspaper box 12 but could conceivably be formed in one of the longitudinally extending faces of box 12. Given its long, open-ended construction, newspaper box 12 is also commonly referred to as a newspaper tube, even when it is not cylindrical in shape.

Door frame 16 is configured for selective mounting around and adjacent to the open, newspaper-receiving end 14 of newspaper box 12. As previously stated, door frame 16 has a frame opening therein through which a newspaper can be inserted into box interior 24. Frame opening 18 is sized relative to frame opening cover 22 such that the frame opening is able to act as a limit stop for movement of frame opening cover 22 (i.e., it prevents frame opening cover 22 from swinging outward away from newspaper box 12). Proximate frame opening 18, door frame 16 has a beveled frame portion 26. Beveled frame portion 26 defines at least a portion of a perimeter of door frame opening 18 and is configured for facilitating the insertion of a newspaper (not shown) through door frame opening 18. The presence of beveled frame portion 26 also helps reduce the potential tearing of the newspaper upon placement thereof within box interior 24.

Door frame 16 further includes a primary frame section 28 and a frame rim 30. Primary frame section 28 has the box fastener 20 mounted thereto and has the frame opening 18 therewithin. Frame rim 30 is one of integral with and attached to primary frame section 18. Frame rim 30 extends away from primary frame section 28. Specifically, frame rim 30 is configured to extend over a portion of newspaper box 12 when door frame 16 is pivoted into a box closing position 32 proximate newspaper-receiving end 14 of newspaper box 12. Frame rim 30 extends around at least a portion of primary frame section 28, thereby increasing the weather tightness created by newspaper box door 10 upon moving it into box closing position 32, relative to newspaper-receiving end 14. Advantageously, frame rim 30 is further sized and arranged so as to aid in retaining newspaper box door 10 adjacent newspaper box 12 when placed in box closing position 32 (e.g., may form a snap-fix with box 12).

Door frame 16 further has a frame handle 34 associated therewith. Frame handle 34 is either integral with or attached to door frame 16. Frame handle 34 facilitates selective opening and closing of newspaper box door 10 relative to newspaper-receiving end 14 of newspaper box 12. Locating frame handle 34 on the side of the door frame 16 opposite box fastener 20 promotes the amount of leverage that can be gained when using frame handle 34 to open box door 10.

Box fastener 20 is pivotally mounted to door frame 16 and is specifically configured to permit attachment of newspaper box 10 to newspaper box 12. Box fastener 20 facilitates the selective pivotal movement of door frame 16 one of toward and away from the open, newspaper-receiving end 14 of the newspaper box 12. In the embodiment illustrated in the figures, the pivot mechanism associated with box fastener 20 is comprised of a plurality of hinges 36. However, it is understood that configurations using one or more hinges 36 could be used to form a pivot mechanism for box fastener 20. Alternatively, other pivot mechanisms such as a ball and socket mechanism (not shown) could be used to facilitate the pivoting action associated with box fastener 20.

The box fastener 20 shown in FIG. 3 is a box clip. Box clip 20 is configured for releasably attaching over a box edge associated with the open, newspaper-receiving end of 14 of newspaper box 12. Although box fastener 20 is shown as a box clip in the current embodiment, it is understood that box fastener 20 could be any one of a variety of fastener mechanisms, either permanent or releasable (examples (not shown) of which are a hinged flange member which can be mechanically threadedly and/or chemically/adhesively bonded to newspaper box 12; and a hinged member with a vise portion for attachment to box 12).

Door frame 16 and box fastener 20 are together configured to permit the newspaper box door 10 to be operably attached to any one of various sized and shaped newspaper boxes 12. The maximum potential box size that can be accommodated by a given newspaper box door 10 is limited by the set of dimensions associated with the perimeter of the door frame 16 (i.e., the portions of frame rim 30 should fall outside of newspaper box 12).

Frame opening cover 22 is pivotally mounted to door frame 16 within newspaper-receiving frame opening 18. Frame opening cover 22 is configured for selectively one of pivotally moving within box interior 24 and resting proximate door frame 16. By having separate and independent pivotal mounts for door frame 16 and frame opening cover 22, newspaper box door 10 of the present invention offers a door-within-a-door structure. This door-within-a-door set-up allows a newspaper to be selectively inserted through a first door (i.e., frame opening cover 22) and retrieved through a second door (i.e., the combination of door frame 16 and frame opening cover 22).

Opening cover 22 includes a first cover portion 38 and a second cover portion 40. The first cover portion has a first edge or side 41 and a second edge or side 42 associated therewith. First cover portion 38 has a first cover hinge 44 located at first edge 41 thereof. First cover hinge unit 44 is hingedly connected to door frame 16. Meanwhile, the second cover portion 40 has a second cover hinge unit 46 associated therewith that is hingedly connected to the second edge 42 of the first cover portion 38. Since first cover portion 38 and second cover portion 40 are hingedly mounted in such a configuration, opening cover 22 defines a bi-fold cover.

Opening cover 22 has an opening cover length 48, opening cover length 48 being measured from first edge 41 of first cover portion 38 to an extreme opposing edge 50 of second cover portion 40, relative to first edge 41. First cover portion 38 has a first swing radius R₁ associated therewith, while second cover portion 40 has a second swing radius R₂ associated with it. The first swing radius R₁ and the second swing radius R₂ are each less than the opening cover length 48, and the first and second hinge units 44 and 46 are configured for operating independently of one another. As a result, the bi-fold cover 22 has an effective bi-fold operating radius R₃ (schematically shown) that is capable of being less than the opening cover length 48.

To explain, upon insertion of a newspaper into newspaper box 12, the initial pivoting associated with frame opening cover 22 will occur primarily at first cover hinge unit 44. Upon contact of frame opening cover 22 with the newspaper (not shown), downward/return movement of opening cover 22 via first cover hinge unit 44 will be impeded. However, due to the overall weight of frame opening cover 22 and any spring bias which may be associated with first cover hinge unit 44, second cover hinge unit 46 will tend to pivot under such conditions. Such pivoting by second cover hinge unit 46 will effectively bring extreme opposing edge 50 of second cover portion 40 closer to first side 41 of first cover portion 38, thereby reducing effective bi-fold operating radius R₃. With such a reduction in radius R₃, frame opening cover 22 can potentially close past a newspaper which would have otherwise blocked it had second cover hinge unit 46 not been available.

Advantageously, at least one of first cover hinge unit 44 and second cover hinge unit 46 is a spring-assisted hinge unit. A spring-assisted hinge unit is useful in that it aids in biasing a respective cover portion 38, 40 toward the door frame 16. The spring constant associated with each hinge unit 44, 46 can be chosen for ease of insertion of a newspaper into newspaper box 12 (i.e., favoring a low modulus of elasticity) or designed to move frame opening cover 22 into contact with frame opening 18 of door frame 16 (i.e., favoring a high modulus of elasticity). Mid-range elasticity values can be chosen for the springs of hinge units 44 and/or 46 so that a given hinge unit 44, 46 may prove rather easy to open, while still promoting closure of the overall frame opening cover 22.

The elasticities of the spring members (not specifically illustrated) of hinge units 44 and 46 do not necessarily have to be the same. It may prove useful to have first cover hinge unit 44 have a low modulus of elasticity to be associated therewith in order to allow the newspaper to be easily inserted therewith, while having the modulus of elasticity associated with second cover hinge unit 46 be relatively large so that it will have a large tendency to want to close if in contact with an end of a newspaper inserted within newspaper box 12. In such an instance, the spring constant associated with first cover hinge unit 44 could be chosen to be low as frame opening cover 22 will be biased to pivot downwardly just due to its own weight.

Another advantage of the bi-fold cover construction and its effective bi-fold operating radius R₃ is that frame opening cover 22 need not necessarily be swung to its maximum open position within box interior 24 upon insertion of a newspaper therethrough. This is especially true if a generally smaller weekday/Saturday edition of the paper is being delivered. By not having it swing so far upward, less of a distance must be traversed in order to gain closure, and even if complete closure is not possible, a larger amount of frame opening 18 should be covered than might have been possible without the presence of second cover hinge unit 46.

Opening cover 22 is advantageously made of a material (e.g., a clear, flexible plastic such as Plexiglass™) that is clear enough so as to permit a visual inspection of the box interior 24 for the presence of a delivered newspaper. To ensure proper selective mounting of door frame 16 around newspaper box 12 and proper attachment of box fastener 20 to newspaper-receiving end 14 of newspaper box 12, it is thereby useful for door frame 16 and box fastener 20 to be made of a clear material so as to visually account for sufficient attachment thereof to newspaper box 12, when desired.

Newspaper box door 10 of the present embodiment is further provided with an indicator flag 52. Indicator flag 52 is pivotally mounted to door frame 16. The indicator flag 52 is configured for pivoting to a delivered-paper flag position 54 that is indicative of a delivered newspaper upon insertion of a newspaper into the box interior 24. In order to pivot the indicator flag into a position indicative of a delivered newspaper, for example, the indicator flag may be coupled to a lever (not shown) which extends into box interior 24, the lever being contacted by a newspaper upon its insertion into newspaper box 12. Such movement by the lever is thereby able to cause indicator flag 52 to move into delivered-paper flag position 54. It is possible that upon removal of the newspaper from box interior 24 the lever could fall under its own weight and/or be spring loaded so as to return to the position it occupied prior to newspaper insertion. Alternatively, such a lever could be manually reset, if needed. Advantageously, the resetting of this lever would simultaneously cause the resetting of indicator flag 52 away from position 54 to a “not delivered” position (not shown).

It is understood that the newspaper box door construction 10 could be extended to use with other roadside delivery receptacles such as mailboxes. It can be seen that certain advantages gained by use of box door 10 could also be useful with respect to mail delivery, especially those associated with the door-within-a-door construct. The generally weather-tight construction as well as the effective bi-fold operating radius R₃ are other features of box door 10 which could prove useful in combination with other delivery box devices.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A newspaper box door for an open, newspaper-receiving end of a newspaper box, the newspaper box having a box interior for accommodating a newspaper therewithin, said newspaper box door comprising:
a door frame configured for selective mounting around and adjacent to the open, newspaper-receiving end of the newspaper box, said door frame having a newspaper-receiving frame opening formed therein;
a box fastener pivotally mounted to said door frame, said box fastener being configured for attaching to the newspaper box and for thereby releasably mounting said door frame to the newspaper box, said box fastener facilitating a pivotal movement of said door frame selectively one of toward and away from the open, newspaper-receiving end of the newspaper box; and
a frame opening cover pivotally mounted to said door frame within said newspaper-receiving frame opening, said frame opening cover being configured for pivotal movement within the box interior.

2. The newspaper box door of claim 1, wherein said frame opening is sized relative to said frame opening cover such that said door frame is thereby able to act as a limit stop for movement of said frame opening cover.

3. The newspaper box door of claim 1, wherein said door frame has a frame handle associated therewith, said frame handle being one of integral with and attached to said door frame, said frame handle facilitating selective opening and closing of the newspaper box door relative to the newspaper-receiving end of the newspaper box.

4. The newspaper box door of claim 3, wherein said frame handle is located on a side of said door frame opposite said box fastener.

5. The newspaper box door of claim 1, wherein said door frame includes a primary frame section and a frame rim, said primary frame section having said box fastener mounted thereto and having said frame opening therein, said frame rim being one of integral with and attached to said primary frame section, said frame rim extending away from said primary frame section, said frame rim being configured to extend over a portion of the newspaper box when said door frame is pivoted into a box closing position proximate the newspaper-receiving end of the newspaper box.

6. The newspaper box door of claim 5, wherein said frame rim extends around at least a portion said primary frame section.

7. The newspaper box door of claim 1, wherein said door frame includes a beveled frame portion, said beveled frame portion defining at least a portion of a perimeter of said door frame opening, said beveled frame portion being configured for facilitating insertion of a newspaper through said door frame opening toward the box interior.

8. The newspaper box door of claim 1, wherein said box fastener is a box clip, said box clip being configured for releasably attaching onto the newspaper box at the open, newspaper-receiving end thereof.

9. The newspaper box door of claim 1, wherein said box fastener is mounted to said door frame via at least one hinge.

10. The newspaper box door of claim 1, wherein said door frame and said box fastener are together configured so as to permit the newspaper box door to be operably attached to any one of various sized and shaped newspaper boxes, a maximum potential box size being limited by a set of dimensions associated with a perimeter of said door frame.

11. The newspaper box door of claim 1, wherein said opening cover includes a first cover portion and a second cover portion, said first cover portion having opposed first and second edges, said first cover portion having a first cover hinge unit at said first edge thereof hingedly connected to said door frame, said second cover portion having a second cover hinge unit hingedly connected to said second edge of said first cover portion, said opening cover thereby defining a bifold cover.

12. The newspaper box door of claim 11, wherein said opening cover has an opening cover length, said opening cover length measured from said first edge of said first cover portion to an extreme opposing edge of said second cover portion, said first cover portion having a first swing radius associated therewith, said second cover portion having a second swing radius associated therewith, said first swing radius and said second swing radius each being less than said opening cover length, said first and second hinge units being configured for operating independently of one another.

13. The newspaper box door of claim 12, wherein said bifold cover has an effective bifold operating radius, said effective bifold operating radius being capable of being less than said opening cover length due to said first and second swing radii and due to said first and second hinge units being configured for operating independently of one another.

14. The newspaper box door of claim 11, wherein at least one of said first hinge unit and said second hinge unit is spring assisted so as to aid in biasing at least one of said first cover portion and said second cover portion toward said door frame.

15. The newspaper box door of claim 1, wherein said opening cover is made of a material that is clear enough so as to permit a visual inspection of the box interior for the presence of a delivered newspaper.

16. The newspaper box door of claim 1, further comprising an indicator flag pivotally mounted to said door frame, said indicator flag being configured for pivoting to a delivered-newspaper flag position upon insertion of a newspaper into the box interior.

17. A newspaper box door for an open, newspaper-receiving end of a newspaper box, the newspaper box having a box interior, said newspaper box door comprising:
a door frame for selective mounting to the open, newspaper-receiving end of the newspaper box, said door frame having a newspaper-receiving frame opening formed therein;
a box fastener pivotally mounted to said door frame, said box fastener being configured for attaching to the newspaper box, said box fastener facilitating a pivotal movement of said door frame selectively one of toward and away from the newspaper box; and
a frame opening cover pivotally mounted to said door frame within said newspaper-receiving frame opening, said frame opening cover being configured for selectively one of pivotally moving within the box interior and resting proximate said door frame.

18. A door assembly for a roadside delivery container, said roadside container having a container interior and an open container end to facilitate access to said container interior, said door assembly permitting selective covering of said open container end, said door assembly comprising:
a door frame having a frame opening therein;
a container fastener pivotally mounted to said door frame, said container fastener being configured for pivotally attaching said door frame to the delivery container; and
a frame opening cover pivotally mounted to said door frame, said frame opening cover being configured for selectably covering said frame opening.

19. The newspaper box door of claim 18, wherein said frame opening cover has a spring-assisted bifold construction.

20. A door assembly for a roadside delivery container, said door assembly comprising:
a door frame having a frame opening;
a fastener pivotally mounted to said door frame, said fastener being configured for pivotally attaching said door frame to the container; and
a frame opening cover pivotally mounted to said door frame, said frame opening cover being configured for selectably covering said frame opening.
